(19) United States
(12) Patent Application Publication
(10) Pub. No.: US 2014/0278563 A1
(43) Pub. Date: Sep. 18, 2014

(54) System and Method to Satisfy Collateral Posting Obligations Under Corporate Insurance Policies Without Usage of Corporate Credit Capacity

(71) Applicants: Philip V. Moyles, JR., Rye, NY (US); Kenneth R. Pierce, Port Washington, NY (US)

(72) Inventors: Philip V. Moyles, JR., Rye, NY (US); Kenneth R. Pierce, Port Washington, NY (US)

(21) Appl. No.: 13/835,713

(22) Filed: Mar. 15, 2013

(51) Int. Cl. G06Q 40/08

(52) U.S. Cl. CPC G06Q 40/08
USPC 705/4

(57) ABSTRACT

Disclosed herein are means by which a company that is obligated to post collateral to secure contractually arising deductible reimbursement obligation may obtain such collateral from a third party without either using its own credit capacity or its own assets. A third party provider of collateral, the Collateral Provider, is paid a fee by a first party in exchange for posting collateral to secure the first party's contractual obligations to a second party. The collateral may either take the form of a letter of credit, or a trust that names the second party as a beneficiary. Through a contractual relationship, the letter of credit issuer or, as applicable, the trustee, assigns its subrogation rights to the Collateral Provider. Optionally and in addition to subrogation, if the credit documents permit, the contract may also require the first party to directly reimburse the Collateral Provider for the amount of the collateral in the event the second party utilizes the collateral provided by the Collateral Provider.

### FIELD OF THE INVENTION

The present invention relates generally to systems and methods for complying with collateral posting obligations. More specifically, the present invention relates to systems and methods that enable corporations to satisfy insurance-related collateral posting obligations without the use of their own assets or bank credit capacity.

### BACKGROUND OF THE INVENTION

Many types of commercial insurance in the United States have high deductibles (i.e., the portion of an insurable loss that is paid by the policyholder rather than the insurer), including workers' compensation and commercial automobile insurance. Because the insurer must pay the loss to the third party (e.g., the injured worker in the case of workers' compensation insurance) and obtain reimbursement from the policyholder for the deductible portion, the insurer is exposed to the credit risk of the policyholder for the deductible portion. Insurers manage this credit risk exposure by requiring policyholders to post collateral. For many decades, corporations in the United States have had to use their own assets or credit facilities with banks in order to satisfy these collateral posting obligations.

Virtually every state in the United States has laws that require a business to maintain insurance policies to cover the business's legal liability to workers and third parties resulting from workplace accidents and other insurable events. In many cases, businesses choose to have very high deductibles on the policies to lower the cost of this insurance. This higher deductible means that in the event the business files an insurance claim based on a loss, the business must pay a significant portion of the loss, rather than the insurer. In practice, and in order to comply with state laws, the insurer is generally obligated to pay the third-party claimant and later obtain reimbursement for the deductible portion of the loss from the policyholder business. As a result, the insurer is exposed to the risk that the policyholder business may be insolvent and unable to satisfy this deductible reimbursement obligation.

One common example of commercial insurance offering high deductible programs is workers' compensation insurance. By way of background, workers' compensation laws require businesses to pay medical expenses, lost wages and to provide other benefits to workers who are injured on the job. These laws require businesses either to obtain insurance or to become a certified self-insurer, so that injured workers are not exposed to the risk that their employer may go insolvent or otherwise be unable to satisfy a workers' compensation award. In other words, workers' compensation insurance shifts the credit risk to the business from the worker to the insurer.

Therefore, when an injured employee makes a workers' compensation claim, the insurance company pays the benefits directly to the employee, and the policyholder business is responsible for reimbursing the insurance company for the amount of the deductible. Typically, the deductible is on a per-worker basis. A typical amount is $500,000 per worker.

Insurance companies frequently require that the policyholder prepay the estimated amount of the policyholder's deductible reimbursement liability into an escrow account that includes approximately three months' worth of expected reimbursement payments. However, virtually every insurer also requires policyholders to post collateral for the deductible obligation. The amount of collateral varies by insurer and policyholder, but generally is sized at the beginning of each annual policy period to equal the aggregate of the expected deductible payments for both (i) all workers injured in prior years for whom payments are expected in the coming year, plus (ii) the estimated aggregate of deductible payments for the number of workers expected to be injured in the coming year.

There are two types of collateral that are generally acceptable to workers' compensation insurers. The first is a letter of credit issued by a bank that is on a list approved by the National Association of Insurance Commissioners naming the insurer as the beneficiary. The second is cash and other assets that are placed into a trust account in which the insurer is the beneficiary. To satisfy the collateral requirement policyholders generally utilize either (i) their own revolving credit lines with banks to obtain the letter of credit or (ii) their own cash or assets to be placed into collateral trusts. Each of these currently available means for fulfilling collateral requirements presents significant problems.

For example, policyholders who obtain letters of credit may be forced to utilize their finite credit capacity with their banks. These letters of credit decrease the amount of working capital available to them under their credit lines. This reduction in credit capacity occurs without any regard to the actual risk that the workers' compensation insurer will draw on the letter of credit. This reduction in credit capacity is particularly problematic for small and middle-market companies and companies with below investment grade credit ratings that have limited credit capacity. By utilizing such a company's limited debt capacity, the letter of credit limits the policyholder's capacity to fund future growth.

The same difficulties occur when a company uses its own cash and other assets to satisfy the collateral posting obligation. Instead of using these funds and assets as working capital, for example, to hire workers or invest in new equipment or technology, these assets sit idle in a trust, pledged to the workers' compensation insurer who will never need to access these funds while the company stays current in making its deductible reimbursement payments.

Compounding the above problems is that it is extremely rare that workers' compensation insurers ever utilize these letters of credit and other collateral posted to actually satisfy the policyholders' deductible reimbursement obligations. This collateral is used purely to provide backup security in the event that the policyholder defaults on its obligation to reimburse the workers' compensation insurer for the deductible portion of claims. The reason such drawdowns are so rare is because the aforementioned workers' compensation laws give state authorities broad powers to take punitive actions against companies who fail to maintain workers' compensation insurance, including the power to shut down operations. Thus, even when companies go insolvent, they generally continue to stay current on their deductible reimbursement payments for fear that, if they default, the insurer will cancel the policy, they will be in violation of the workers' compensation laws, and they may be shut down by state workers' compensation authorities—preventing a reorganization in bankruptcy or an orderly liquidation.

Since every company in the United States is required to obtain either workers' compensation insurance or a certificate of self-insurance, the aggregate value of these letters of credit and collateral trusts in the country at any given time is very large. Some estimates place the aggregate value at greater than $50 billion. Thus, in sum, there is over $50 billion in idle capital and consumed credit capacity that could be released and deployed in the broader economy as a result of the present invention. Hence, a system and method that satisfies the insurers' collateral requirements while relieving the policyholder of usage of its own credit lines or assets would be of widespread utility in the United States.

### SUMMARY OF THE INVENTION

Disclosed herein are systems and methods by which a first party is under a contractual obligation to a second party to post collateral to secure contractually arising deductible reimbursement obligations, and that first party may obtain such collateral from a third party without either using its own credit capacity or its own assets. For example, the deductible reimbursement obligation may arise out of an insurance contract that requires that a policyholder reimburse an insurer for the amount of its deductible under the contract. In a preferred embodiment of the present invention, the insurance contract that gives rise to the policyholder's deductible posting obligation is required by state law. In another preferred embodiment, the insurance is workers' compensation insurance or automobile insurance.

In the systems and methods described herein, a third party provider of collateral, the Collateral Provider, is paid a fee by the first party in exchange for posting collateral to secure the policyholder's deductible reimbursement obligations. In certain embodiments, the Collateral Provider determines whether the alternative collateral transaction is possible based upon an analysis of the company's credit facility and then determines the price for the transaction.

In certain embodiments, the Collateral Provider posts collateral on behalf of the first party directly. Alternatively, the Collateral Provider pays a fee to an Alternative Letter of Credit Investment Vehicle, which then in turn posts the collateral to secure the first party's deductible reimbursement obligation.

In a preferred embodiment, the Collateral Provider or Alternative Letter of Credit Investment Vehicle fulfills the first party's collateral posting obligation by renting out its own letter of credit facility and furnishing such letter of credit to the second party. The Collateral Provider or Alternative Letter of Credit Investment Vehicle utilizes its own capital to obtain a letter of credit issued by a lender that is on a list approved by the National Association of Insurance Commissioners, and it names the second party as beneficiary. Through a contractual relationship, the lender assigns its subrogation rights to the Collateral Provider or Alternative Letter of Credit Investment Vehicle.

In an alternative embodiment of the present invention, the Collateral Provider fulfills the first party's collateral posting obligation by posting cash or other assets to a collateral trust that names the second party as the beneficiary. Through a contractual relationship, the trustee of the collateral trust assigns its subrogation rights to the Collateral Provider.

In an alternative embodiment of the present invention, under the contractual arrangement between the first party and the Collateral Provider, the first party provides to the Collateral Provider a direct right of reimbursement in the event the collateral is drawn by the second party, or if such a direct right would violate the first party's credit agreement, the first party confirms the Collateral Provider's subrogation rights and provides other assurances that it will continue to honor its deductible reimbursement obligations to the second party.

Through the use of the systems and methods described herein, the Collateral Provider can accomplish two critical objectives:

First, the systems and methods described herein provide a specific methodology by which the Collateral Provider is able to evaluate not merely the risk that the first party may go insolvent, but also the risk that the collateral that it provides will actually be utilized by the second party. This methodology utilizes a computer program that processes various data items, including both traditional factors that are used in credit analysis, as well as specialized factors that evaluate the risk that the second party will draw upon the collateral.

Second, the systems and methods described herein provide to the Collateral Provider a right of recovery against the first party in the event of a drawdown that does not constitute indebtedness or financial leverage that would consume credit capacity under the policyholder's existing credit lines, or otherwise violate the terms of any credit agreements or indentures between the first party and its existing lenders. This is accomplished through a highly structured arrangement between the Collateral Provider and the first party through which the Collateral Provider subrogates to the second party's legal right to obtain reimbursement for the deductible portion of the claim or, if the existing credit agreement permits, a direct reimbursement arrangement between the first party and the Collateral Provider.

### BRIEF DESCRIPTION OF THE DRAWINGS

The present invention is described below in connection with the following illustrative figures, wherein like reference numbers refer to like elements throughout, and wherein

FIG. 1 is a process flow demonstrating the steps of one embodiment of the present invention.

FIG. 2 is a process flow demonstrating the steps of one embodiment of the present invention.

FIG. 3 is a block diagram demonstrating one embodiment of the present invention.

FIG. 4 is a block diagram demonstrating one embodiment of the present invention.

### DETAILED DESCRIPTION OF THE INVENTION

While the present invention is capable of embodiment in various forms, there is shown in the drawings, and will be hereinafter described, one or more presently preferred embodiments with the understanding that the present disclosure is to be considered as an exemplification of the invention, and is not intended to limit the invention to the specific embodiments illustrated herein. Headings are provided for convenience only and are not to be construed to limit the invention in any way. Embodiments or aspects thereof illustrated under any heading may be combined with embodiments illustrated under any other heading.

Described below are means for securing a first party's deductible reimbursement obligation to a second party. A third-party provider of Collateral, either on its own or through an Alternative Letter of Credit Investment Vehicle created for purposes of posting the collateral obligation, fulfills the first party's collateral posting obligation by renting out its own letter of credit facility or posting cash or assets to a collateral trust that names the second party as the beneficiary. Where the Collateral Provider or Alternative Letter of Credit Investment Vehicle obtains a letter of credit from a lender, the lender assigns its subrogation rights. The first party is not in privity with the lender and has no direct reimbursement obligation to the lender and, therefore, the first party's existing credit means are not utilized. In the event that the first party draws on the letter of credit, the Collateral Provider or Alternative Letter of Credit Investment Vehicle subrogates to the second party's legal right to obtain reimbursement for the deductible portion of the claim. In addition, if the existing credit agreement permits, there is a direct reimbursement arrangement between the first party and the Collateral Provider.

### Illustrative Structure of Transaction

In an embodiment of the present invention, a first party is under a contractual obligation to post collateral to secure an obligation under a contract giving rise to subrogation. In a preferred embodiment, the contract is an insurance contract, and a first-party policyholder is obligated to post collateral to secure a deductible reimbursement obligation to a second-party insurer. However, one of ordinary skill in the art will recognize that the present invention is not limited to insurance contracts, but could be utilized for any contractual relationship that gives rise to subrogation.

Optionally, the insurance contract may be related to an insurance policy that is mandatory for the policyholder to carry under state law, such as workers' compensation insurance or automobile liability insurance. Optionally, the contract may also require that the policyholder maintain an escrow account.

### Assessing the Creditworthiness of the First Party

In an embodiment of the present invention, the Collateral Provider first undertakes an analysis to determine whether the alternative collateral transaction is possible based upon an analysis of the first party's credit facility and the deductible reimbursement arrangement as between the first party and the second party. Optionally, this step includes the use of an algorithm that analyzes various inputs, including a scan and analysis of the first party's credit facility documents, deductible and collateral agreements, and produces an output consisting of a package of form transaction documents and a minimum price for the collateral.

As a first phase of this analysis, the algorithm determines whether the alternative collateral transaction is possible based upon an analysis of the first party's credit facility deductible reimbursement documents, establishing word sets, determining word overlaps between these sets, and through additional calculations reaching a positive or negative conclusion. This phase is described in steps one through five below. In the next phase, the algorithm undertakes a credit analysis of the first party, employing credit factors to determine whether the alternative collateral transaction is possible based upon whether the first party is an acceptable credit risk. The algorithm also undertakes an analysis of the collateral draw-down triggers contained in the deductible reimbursement or collateral agreement. If the output is positive, the minimum price is set based upon the price of the client first party's deeply subordinated debt. Any of these phases may be conducted using any computer having a display, inputs, and one or more processors and software therein to program the processors to execute the functionality described herein.

As shown in FIG. 1, in the first step of the analysis, a data set regarding the financial condition of the first party is received 10. This data set may include data regarding the first party's debt obligations, deductible reimbursement obligations, and collateral draw down triggers (i.e., situations in which a second party may draw down upon the letter of credit or collateral furnished by the Collateral Provider). This data set may also include data retrievable from the first party's existing credit facility transaction documents, including the credit or revolver agreement and any addenda or schedules (collectively, the “CFT Documents”). In one embodiment, this data set is received by optically scanning the CFT Documents into a computer using a scanning service or device that enables the computer to extract text from the CFT Documents so this text can be searched for certain key words. Alternatively, data representing the first party's credit facilities may be manually entered. Additionally, data representing the amount of collateral required for the transaction are received 13.

In the second step of the analysis, the data set received is analyzed 11 to determine whether the first party will qualify for the collateral arrangement with the Collateral Provider or whether the structure and terms of the CFT Documents would preclude the arrangement. Referring to FIG. 2, the data are analyzed to identify words that relate to liabilities and collateral obligations 15. It is then determined whether said words relating to liabilities and collateral obligations overlap with words relating to debt 16. A computer (i) performs a scan of the CFT Documents for a key word including singular and plural variations, as well as words that subsume this key word; (ii) using optical scan technology and text searching functionality (such as might be exhibited by the “find” feature found in standard word processing applications), isolates words that follow the key word in a subparagraph, definition, or continuation of a section or article in which the key word is used; and (iii) generates a series of sets that include all such words that are within the definition, article, or subsection in which the key word is used, and assigns factor “A” to each set (for example, Aa, Ab, Ac, Ad, Az, and collectively, the “A sets”). The “A set” of words includes words or phrases that relate to the first party's debt capacity under the CFT Documents. Key words and phrases for which a computer may scan include words such as “debt,” and words that subsume these words include terms such as “indebtedness,” “leverage,” and “obligations.”

In the third step of the analysis, the computer then scans the A sets to determine whether such sets include words that are included within the set of words, B, which includes all words that are relevant to collateral requirements. The “B set” of words relates to the first party's liabilities and collateral obligations to determine whether the collateral to be provided by the Collateral Provider would be subsumed, including, but not limited to, the words and phrases “letter of credit,” “liabilities,” “contingent,” and “collateral,” including singular and plural variations, as well as words and phrases that subsume these words and phrases. If there is no overlap between the A sets and the B sets, then proceed to Step 6. If there is any overlap between the A sets and the B sets, then proceed to Step 4.

In the fourth step of the analysis 17, a computer scans the entire set of CFT Documents for the “C sets” of words, which include all words describing whether a practice is allowed or disallowed, and grammatical or syntactical variations of those words. Words connoting allowance include, but are not limited to “allow,” “permit,” “let,” “consent,” “enter,” “incur,” and “exist.” Words connoting disallowance include “prohibit,” “disallow,” “forbid,” “ban,” “bar,” “stop,” “prevent,” “shall not,” “will not,” and “agree not to.” Words connoting disallowance are assigned a negative factor (“C-Negative”), and words connoting permission or allowance are assigned a positive factor (“C-Positive”).

In the fifth step of the analysis 18, a computer determines and displays if any words in the C set appear within a certain threshold number of words on either side of any words in the B set, such as, for example, within 25 words. If either (i) none so appear, or (ii) only C-Positive words so appear, then the analysis proceeds to Step 6. If C-Negative words so appear, then the CFT documents are provided to counsel for further analysis to determine whether the alternative collateral transaction documents can be further refined or modified to address the C-Negative situations identified by the computer. If so, then the analysis proceeds to Step 6. If not, then the alternative collateral transaction is disallowed. The computer displays whether the alternative collateral transaction is allowed or disallowed 19.

In the sixth step of the analysis, the computer undertakes a credit analysis of the first party to determine whether the alternative collateral transaction is possible based upon whether the company presents an acceptable credit risk. If the output is positive, proceed to Step 7 for pricing and construction of the collateral arrangement with the Collateral Provider. If negative, then the alternative collateral transaction is disallowed. The computer driven credit analysis optionally employs a scoring sub-algorithm, which assigns and weights various factors across different categories, as shown in Table 1 below.

TABLE 1
Data Dimensions

| Factor | Weight | Score |
|---|---|---|
| Company | | |
| Industry | .01 | |
| Years in Business | .005 | |
| Strategy | .05 | |
| | .065 | |
| Credit | | |
| Capital Structure | .125 | |
| EBITDA | .2 | |
| Liquidity | .130 | |
| Credit Rating | .005 | |
| Leverage Ratio | .165 | |
| No. of debt tranches | .005 | |
| Yield on tranches | .1 | |
| Insurance | | |
| WC LOC Amount | .005 | |
| LC Drawdown triggers | .05 | |
| Cancellation provisions | .05 | |
| | .10 | |
| Bankruptcy | | |
| WC LC drawn in past | .10 | |

Each factor in Table 1 is assigned a weighting fraction of between 0.01 and 0.99, provided that the sum of all weighting factors equals 1.0.

The company is scored either positive 1.0 or negative 1.0 for each factor, depending on the specific factual characteristics of the first party, and such score is multiplied by the weighting fraction for the applicable factor. The product is the “Weight Adjusted Score” for the applicable factor.

The Weight Adjusted Scores [az] are tallied. If the sum of all Weight Adjusted Scores is a positive number, then the first party qualifies for the alternative collateral transaction, and the analysis proceeds to Step 7. If negative, then the first party does not qualify for the alternative collateral transaction, and the alternative collateral transaction is disallowed. The result of whether an alternative collateral transaction is allowed or disallowed is outputted 12.

In the seventh and final step of the analysis, a minimum fee is indicated 14 based upon the price of the first party's deeply subordinated debt or in some cases, mezzanine equity. In addition, in Step 7 a determination is made as to the terms and structure of the collateral arrangement between the first party and the Collateral Provider, which in turn depends upon the analysis and output of Steps 1 through 5. For example, if “letters of credit” or “contingent indebtedness” are “forbidden” under the CFT documents, then the Collateral Provider's recourse against the first party will be limited to the subrogation approach. If, however, the computer driven process set forth above does not disclose such a prohibition, then a direct claim by the Collateral Provider for reimbursement against the first party may be permitted. The output of Steps 6 and 7 are furnished to the businesspersons responsible for negotiation with the first party, and a transaction using the technology is negotiated and concluded.

### Implementing the Transaction

In FIG. 3, the first party 1 pays a fee 2 to the Collateral Provider 3. Optionally, this fee 2 has been determined by the preferred embodiment described in further detail above, whereupon the fee is displayed to the parties through the use of hardware and software capable of displaying such information, such as described below. Optionally, this fee may be transmitted via a computer or other processor as further described herein before being displayed. In addition, the agreement containing the terms of the fee 2 includes an acknowledgement by the first party of the Collateral Provider's subrogation rights. In addition, depending on the output of Steps 1 through 5 above and whether such a term is “permitted,” the agreement containing the terms of the fee 2 may also include a direct obligation on the part of the first party to reimburse the Collateral Provider if the second party utilizes the collateral provided by the Collateral Provider.

In a preferred embodiment, the Collateral Provider 3 fulfills the first party's collateral posting obligation by renting out its own letter of credit facility so that a lender 6 will furnish such letter of credit 7 to the second party 8. This can be accomplished by utilizing an existing credit relationship with the lender or entering into a new credit agreement with the lender. The Collateral Provider utilizes its own capital to obtain a letter of credit issued by a lender that is on a list approved by the National Association of Insurance Commissioners, and it names the second party as beneficiary. The lender 6 then provides the letter of credit 7 to the second party 8. Optionally, this letter of credit is furnished to the second party or obtained from the lender via a computer or other processor as further described herein

Through a contractual relationship, in exchange for an existing or new credit agreement 5 with the Collateral Provider 3, the lender 6 assigns its subrogation rights 4 to the Collateral Provider 3. As a result, in the event that the second party draws on the letter of credit, the Collateral Provider's rights subrogate to the rights of the insurer. The Collateral Provider therefore has a right to recover the premiums due from the first party.

In a preferred embodiment, the Collateral Provider fulfills the first party's collateral posting obligation by providing cash, securities, or other assets to a trust, which names the second party as the beneficiary of the trust.

As shown in FIG. 4, in an alternative embodiment, the first party 1 pays a fee 2 to the Collateral Provider 3, which then pays the fee 2 to the alternative letter of credit investment vehicle 9. Alternatively, the fee is used as capital by which to fund the alternative letter of credit investment vehicle. The alternative letter of credit investment vehicle 9 utilizes a new or existing credit agreement 5 with the lender 6, and the lender 6 assigns its subrogation rights 4 to the alternative letter of credit investment vehicle 9, which in turn assigns its subrogation rights 3 to the Collateral Provider 3. The lender 6 then furnishes the letter of credit 7 to the second party 8. In the event of a drawdown, the Collateral Provider retains its right of recovery against the first party. In addition, the agreement containing the terms of the fee 2 includes an acknowledgement by the first party of the Collateral Provider's subrogation rights. In addition, depending on the output of Steps 1 through 5 above and whether such a term is “permitted,” the agreement containing the terms of the fee 2 may also include a direct obligation on the part of the first party to reimburse the Collateral Provider if the second party ever utilizes the collateral provided by the Collateral Provider.

As still another alternative environment, the transaction involves two or more Collateral Providers or alternative letter of credit investment vehicles. In this embodiment, the transaction proceeds similarly to the embodiments described above, with the exception that the collateral provided and agreements include provisions to account for multiple Collateral Providers. One example of such contracts is automobile liability insurance contracts.

Because the credit agreement is between the bank and the alternative letter of credit investment vehicle rather than the first party, the first party is not in privity with the lender. The letter of credit does not affect the first party's available credit facilities or bank revolver lines.

Optionally, the first party is a policyholder, and the second party is an insurer. However, the present invention is not limited to an insurance policy, but extends to any contract that gives rise to subrogation rights and requires a letter of credit as collateral.

While the invention has been described in terms of several preferred embodiments, it should be understood that there are many alterations, permutations, and equivalents that fall within the scope of this invention. It should also be noted that there are alternative ways of implementing both the process and apparatus of the present invention. For example, steps do not necessarily need to occur in the orders shown in the accompanying figures, and may be rearranged as appropriate. It is therefore intended that the appended claim includes all such alterations, permutations, and equivalents as fall within the true spirit and scope of the present invention.

### Risk to Collateral Provider

As described herein, the present invention applies generally to insurance that is mandatory for conducting business under state law. The present invention uniquely recognizes that such insurance contracts present low risks to a Collateral Provider, whether through an alternative letter of credit investment vehicle or by the posting of cash, securities, or assets into a trust. This limited risk is a novel benefit of the present invention.

An insurer can draw on a letter of credit or draw funds from a trust when a company stops paying its obligations under the underlying contract, such as insurance premiums or deductibles, and the full amount of any escrow account has been depleted, which would mean that the policyholder is in default on its insurance policy. In the case of state-mandated insurance, a policyholder is likely to pay its insurance premiums and deductibles before other expenses, because in the event it fails to pay these expenses, it may no longer be able to do business.

The risk to a Collateral Provider is also minimized by the existence of an escrow account. The Collateral Provider can receive notice when an escrow account falls below normal levels, alerting the alternative letter of credit investment vehicle to a risk of default. In this embodiment, the system continuously monitors the funds in the escrow account. When the escrow account falls below a threshold level, an alert is generated and transmitted to the alternative letter of credit investment vehicle. The threshold level is determined based on well-known means for determining an appropriate level of funds. For example, the escrow threshold can be set as approximately three months' worth of expected reimbursement payments. As another example, the threshold could be sized at the beginning of each annual policy period to equal the aggregate of the expected deductible payments for both (i) all workers injured in prior years for whom payments are expected in the coming year, plus (ii) the estimated aggregate of deductible payments for the number of workers expected to be injured in the coming year. The threshold may “be” increased or decreased based on the first party's credit facilities and the level of risk for default posed by the first party and the underlying insurance agreement.

Although the systems and methods herein have been described above with respect to certain embodiments, it will be readily apparent that the systems and methods described herein are equally applicable to other types of insurance and other contracts that present similar collateral requirements. For example, any business that utilizes a fleet of automobiles, such as cars or trucks, must maintain automobile liability insurance under state law and must post the same types of collateral to secure the insurer's exposure to credit risk in respect of their deductible reimbursement obligations.

### Means for Performing Method Steps of the Invention

The invention can be implemented in digital electronic circuitry, or in computer hardware, firmware, software, or in combinations thereof. The invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. The essential elements of a computer are a processor for executing instructions and one or more memory devices for storing instructions and data. The processor receives instructions and data from a read only memory, or a random access memory, or both. The computer may also include, or be operatively coupled to receive data from or transfer data to, or both, one or more mass storage devices for storing data, e.g., magnetic, magneto optical disks, or optical disks. Information carriers suitable for embodying computer program instructions and data include all forms of non-volatile memory including, by way of example, semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by or incorporated in special purpose logic circuitry.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of this disclosure (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples or exemplary language (e.g., such as, preferred, preferably) provided herein is intended merely to further illustrate the content of the disclosure and does not pose a limitation on the scope of the claims. No language in the specification should be construed as indicating any non-claimed element as essential to the practice of the present disclosure.

Multiple embodiments are described herein, including the best mode known to the inventors for practicing the claimed invention. Of these, variations of the disclosed embodiments will become apparent to those of ordinary skill in the art upon reading the foregoing disclosure. The inventors expect skilled artisans to employ such variations as appropriate (e.g., altering or combining features or embodiments), and the inventors intend for the invention to be practiced otherwise than as specifically described herein.

Accordingly, this invention includes all modifications and equivalents of the subject matter recited in the claims appended hereto as permitted by applicable law. Moreover, any combination of the above described elements in all possible variations thereof is encompassed by the invention unless otherwise indicated herein or otherwise clearly contradicted by context.

The use of individual numerical values are stated as approximations as though the values were preceded by the word “about” or “approximately.” Similarly, the numerical values in the various ranges specified in this application, unless expressly indicated otherwise, are stated as approximations as though the minimum and maximum values within the stated ranges were both preceded by the word “about” or “approximately.” In this manner, variations above and below the stated ranges can be used to achieve substantially the same results as values within the ranges. As used herein, the terms “about” and “approximately” when referring to a numerical value shall have their plain and ordinary meanings to a person of ordinary skill in the art to which the disclosed subject matter is most closely related or the art relevant to the range or element at issue. The amount of broadening from the strict numerical boundary depends upon many factors. For example, some of the factors that may be considered include the criticality of the element and/or the effect a given amount of variation will have on the performance of the claimed subject matter, as well as other considerations known to those of skill in the art. As used herein, the use of differing amounts of significant digits for different numerical values is not meant to limit how the use of the words “about” or “approximately” will serve to broaden a particular numerical value or range. Thus, as a general matter, “about” or “approximately” broaden the numerical value. Also, the disclosure of ranges is intended as a continuous range including every value between the minimum and maximum values plus the broadening of the range afforded by the use of the term “about” or “approximately.” Thus, recitation of ranges of values herein are merely intended to serve as a shorthand method of referring individually to each separate value falling within the range, unless otherwise indicated herein, and each separate value is incorporated into the specification as if it were individually recited herein.

It is to be understood that any ranges, ratios, and ranges of ratios that can be formed by, or derived from, any of the data disclosed herein represent further embodiments of the present disclosure and are included as part of the disclosure as though they were explicitly set forth. This includes ranges that can be formed that do or do not include a finite upper and/or lower boundary. Accordingly, a person of ordinary skill in the art most closely related to a particular range, ratio, or range of ratios will appreciate that such values are unambiguously derivable from the data presented herein.

We claim:

1. A method of implementing an alternative collateral transaction that provides collateral on behalf of a first party under a contractual obligation to provide collateral to a second party, wherein said contractual obligation gives rise to subrogation, using an alternative collateral transaction that provides maximum protection of the collateral provider's rights against the first party and does not violate or breach the first party's existing credit agreements, the method comprising the steps of:
receiving a data set relating to the first party;
analyzing said data set to determine the credit-worthiness of the first party;
outputting whether an alternative collateral transaction is allowed or disallowed for the first party based on the analysis of the data set;
receiving data representing the amount of collateral required by the contractual obligation;
calculating a fee amount to charge said first party based on the credit-worthiness of the first party and amount of collateral required in exchange for obtaining collateral from a lender, receiving an assignment of the lender's right of subrogation, and providing collateral to the second party to satisfy the first party's contractual obligation; and
displaying said fee; and
wherein at least the steps of receiving a data set, analyzing said data set, outputting whether an alternative collateral transaction is allowed or disallowed, calculating a fee, and displaying said fee are performed by a computer having programming designed to execute these steps.

2. The method of claim 1 wherein the data set comprises data representing the first party's debt.

3. The method of claim 1 wherein the data set comprises data representing the first party's deductible reimbursement obligations.

4. The method of claim 1 wherein the data set comprises data representing the first party's collateral draw down triggers.

5. The method of claim 1 wherein the contractual obligation is created by a workers' compensation insurance contract.

6. The method of claim 1 wherein the contractual obligation is created by an automobile insurance contract.

7. The method of claim 1 wherein the step of receiving a data set comprises scanning the policyholder's credit facility documents using optical scan technology.

8. The method of claim 1 wherein the step of receiving a data set comprises scanning said agreements using optical scan technology.

9. The method of claim 1, further comprising the step of providing collateral to satisfy the first party's contractual obligations.

10. The method of claim 9, wherein the form of the collateral is a letter of credit.

11. The method of claim 9, wherein the collateral comprises assets to be deposited into a trust for the benefit of the second party.

12. The method of claim 11, wherein the assets comprise cash.

13. The method of claim 11, wherein the assets comprise securities.

14. A method of implementing an alternative collateral transaction that provides collateral on behalf of a first party under a contractual obligation to provide collateral to a second party, wherein said contractual obligation gives rise to subrogation, using an alternative collateral transaction that provides maximum protection of the collateral provider's rights against the first party and does not violate or breach the first party's existing credit agreements, the method comprising the steps of:
receiving a data set relating to the financial condition of the first party;
analyzing said data to identify words that relate to the first party's liabilities and collateral obligations; and
determining whether said words relating to the first party's debt overlap with said words relating to the first party's liabilities and collateral obligations;
optionally analyzing said data to identify words that relate to whether a practice is allowed or disallowed;
optionally outputting whether a practice is allowed or disallowed appear within twenty-five words of a word relating to the first party's liabilities and collateral obligations;
outputting whether an alternative collateral transaction is allowed or disallowed for the first party based on the analysis of the data set;
receiving data representing the amount of collateral required by the contractual obligation;
calculating a fee amount to charge said first party based on the credit-worthiness of the first party and amount of collateral required in exchange for obtaining collateral from a lender, receiving an assignment of the lender's right of subrogation, and providing collateral to the second party to satisfy the first party's contractual obligation;
displaying said fee amount; and
wherein at least the steps of receiving a data set, analyzing said data, optionally outputting whether a practice is allowed or disallowed, outputting whether an alternative collateral transaction is allowed or disallowed, determining a fee amount; and displaying said fee amount are performed by a computer having programming designed to execute these steps.

15. The method of claim 14 wherein the data set comprises data representing the first party's debt.

16. The method of claim 14 wherein the data set comprises data representing the first party's deductible reimbursement obligations.

17. The method of claim 14 wherein the data set comprises data representing the first party's collateral draw down triggers.

18. The method of claim 14 wherein the contractual obligation is created by a workers' compensation insurance contract.

19. The method of claim 14 wherein the contractual obligation is created by an automobile insurance contract.

20. The method of claim 14 wherein the step of receiving a data set comprises scanning the policyholder's credit facility documents using optical scan technology.

21. The method of claim 14 wherein the receiving a data set comprises scanning said agreements using optical scan technology.

22. The method of claim 14, further comprising the step of providing collateral to satisfy the first party's contractual obligations.

23. The method of claim 22, wherein the form of the collateral is a letter of credit.

24. The method of claim 22, wherein the collateral comprises assets to be deposited into a trust for the benefit of the second party.

25. The method of claim 24, wherein the assets comprise cash.

26. The method of claim 24, wherein the assets comprise securities.

27. A method of implementing an alternative collateral transaction that provides collateral on behalf of a first party under a contractual obligation to provide collateral to an second party, wherein said contractual obligation gives rise to subrogation, using an alternative collateral transaction that provides maximum protection of the collateral provider's rights against the first party and does not violate or breach the first party's existing credit agreements, the method comprising the steps of:
assessing the credit-worthiness of a first party under a contractual obligation to provide collateral to a second party, wherein the contractual obligation gives rise to subrogation, said assessment comprising the steps of receiving a data set relating to the financial condition of the first party, analyzing said data set, and outputting whether an alternative collateral transaction is allowed or disallowed for the first party based on the analysis of the data set;
identifying factors relevant to the policyholder's creditworthiness;
assigning weighting fractions of 0.01 to 0.99 to said factors relevant to the policyholder's creditworthiness;
assigning the policyholder a positive score of 1.0 or negative score of 1.0 for each factor;
multiplying the weighting fraction by the applicable factor score to produce a weighted adjusted score;
obtaining the sum of all weighted adjusted scores;
outputting whether an alternative collateral transaction is allowed or disallowed based on the sum of all weighted adjusted scores;
calculating a fee amount to charge said first party based on the credit-worthiness of the first party and amount of collateral required in exchange for obtaining collateral from a lender, receiving an assignment of the lender's right of subrogation, and providing collateral to the second party to satisfy the first party's contractual obligation; and
displaying said fee amount;
wherein at least the steps of assessing the credit-worthiness of a first party, assigning weighting fractions, assigning the policyholder a positive score of 1.0 or negative score of 1.0, multiplying the weighted fraction by the applicable factor score, obtaining the sum of all weighted adjusted scores, outputting whether an alternative collateral transaction is allowed or disallowed, and calculating a fee amount, and displaying said fee amount are performed by a computer having programming designed to execute these steps.

28. The method of claim 27 wherein the data set further comprises data representing the first party's debt.

29. The method of claim 27 wherein the data set further comprises data representing the first party's deductible reimbursement obligations.

30. The method of claim 27 wherein the data set further comprises data representing the first party's collateral draw down triggers.

31. The method of claim 27 wherein the contractual obligation is created by a workers' compensation insurance contract.

32. The method of claim 27 wherein the contractual obligation is created by an automobile insurance contract.

33. The method of claim 27 wherein the step of receiving a data set comprises scanning the policyholder's credit facility documents using optical scan technology.

34. The method of claim 27 wherein the receiving a data set comprises scanning said agreements using optical scan technology.

35. The method of claim 27, further comprising the step of providing collateral to satisfy the first party's contractual obligations, wherein the step of providing collateral to satisfy the first party's contractual obligations is performed by a computer having programming designed to execute these steps.

36. The method of claim 35, wherein the form of the collateral is a letter of credit.

37. The method of claim 35, wherein the collateral comprises assets to be deposited into a trust for the benefit of the second party.

38. The method of claim 37, wherein the assets comprise cash.

39. The method of claim 37, wherein the assets comprise securities.

40. A non-transitory computer-readable medium for implementing a transaction to provide collateral on behalf of a first party under a contractual obligation to provide collateral to an second party, wherein said contractual obligation gives rise to subrogation, using an alternative collateral transaction that provides maximum protection of the collateral provider's rights against the first party and does not violate or breach the first party's existing credit agreements, and in which a party providing the alternative collateral transaction vehicle obtains collateral from a lender, receives an assignment of the lender's right of subrogation, and provides collateral to the second party to satisfy the first party's collateral obligation, said computer-readable medium bearing a computer program containing instructions which, when implemented by a computer, cause the computer to execute the steps of:
receiving a data set relating to the first party;
analyzing said data set to determine the credit-worthiness of the first party;
outputting whether an alternative collateral transaction is allowed or disallowed for the first party based on the analysis of the data set;
receiving data representing the amount of collateral required by the contractual obligation;
calculating a fee amount to charge said first party based on the credit-worthiness of the first party and amount of collateral required in exchange for obtaining collateral from a lender, receiving an assignment of the lender's right of subrogation, and providing collateral to the second party to satisfy the first party's contractual obligation; and
displaying said fee amount.

41. The method of claim 40 wherein the data set further comprises data representing the first party's debt.

42. The method of claim 40 wherein the data set further comprises data representing the first party's deductible reimbursement obligations.

43. The method of claim 40 wherein the data set further comprises data representing the first party's collateral draw down triggers.

44. The method of claim 40 wherein the contractual obligation is created by a workers' compensation insurance contract.

45. The method of claim 40 wherein the contractual obligation is created by an automobile insurance contract.

46. The method of claim 40 wherein the step of receiving a data set comprises scanning the policyholder's credit facility documents using optical scan technology.

47. The method of claim 40 wherein the receiving a data set comprises scanning said agreements using optical scan technology.

48. The method of claim 40, further comprising the step of providing collateral to satisfy the first party's contractual obligations, wherein the step of providing collateral to satisfy the first party's contractual obligations is performed by a computer having programming designed to execute these steps.

49. The method of claim 48, wherein the form of the collateral is a letter of credit.

50. The method of claim 48, wherein the collateral comprises assets to be deposited into a trust for the benefit of the second party.

51. The method of claim 50, wherein the assets comprise cash.

52. The method of claim 50, wherein the assets comprise securities.

53. A method of implementing an alternative collateral transaction that provides collateral on behalf of a first party under a contractual obligation to provide collateral to an second party, wherein said contractual obligation gives rise to subrogation, using an alternative collateral transaction that provides maximum protection of the collateral provider's rights against the first party and does not violate or breach the first party's existing credit agreements, the method comprising the steps of:
receiving a data set relating to the first party;
analyzing said data set to determine the credit-worthiness of the first party;
outputting whether an alternative collateral transaction is allowed or disallowed for the first party based on the analysis of the data set;
receiving data representing the amount of collateral required by the contractual obligation;
calculating a fee amount to charge said first party based on the credit-worthiness of the first party and amount of collateral required in exchange for providing collateral to the second party to satisfy the first party's contractual obligation;
displaying said fee amount;
wherein at least the steps of receiving a data set, analyzing said data set, outputting whether an alternative collateral transaction is allowed or disallowed, calculating a fee amount; and displaying said fee amount are performed by a computer having programming designed to execute these steps.

54. The method of claim 53 wherein the data set further comprises data representing the first party's debt.

55. The method of claim 53 wherein the data set further comprises data representing the first party's deductible reimbursement obligations.

56. The method of claim 53 wherein the data set further comprises data representing the first party's collateral draw down triggers.

57. The method of claim 53 wherein the contractual obligation is created by a workers' compensation insurance contract.

58. The method of claim 53 wherein the contractual obligation is created by an automobile insurance contract.

59. The method of claim 53 wherein the step of receiving a data set comprises scanning the policyholder's credit facility documents using optical scan technology.

60. The method of claim 53 wherein the receiving a data set comprises scanning said agreements using optical scan technology.

61. The method of claim 53, wherein the collateral comprises assets to be deposited into a trust for the benefit of the second party.

62. The method of claim 61, wherein the assets comprise cash.

63. The method of claim 61 wherein the assets comprise securities.

64. A method of implementing an alternative collateral transaction that provides collateral on behalf of a first party under a contractual obligation to provide collateral to an second party, wherein said contractual obligation gives rise to subrogation, using an alternative collateral transaction that provides maximum protection of the collateral provider's rights against the first party and does not violate or breach the first party's existing credit agreements, the method comprising the steps of:
receiving a data set relating to the first party;
analyzing said data to identify words that relate to the first party's liabilities and collateral obligations; and
determining whether said words relating to the first party's debt overlap with said words relating to the first party's liabilities and collateral obligations;
optionally analyzing said data to identify words that relate to whether a practice is allowed or disallowed;
optionally outputting whether a practice is allowed or disallowed appear within twenty-five words of a word relating to the first party's liabilities and collateral obligations;
outputting whether an alternative collateral transaction is allowed or disallowed for the first party based on the analysis of the data set;
receiving data representing the amount of collateral required by the contractual obligation;
calculating a fee amount to charge said first party based on the credit-worthiness of the first party and amount of collateral required in exchange for providing collateral to the second party to satisfy the first party's contractual obligation;
displaying said fee amount; and
wherein at least the steps of receiving a data set, analyzing said data, optionally outputting whether a practice is allowed or disallowed, outputting whether an alternative collateral transaction is allowed or disallowed, and calculating a fee amount, and displaying said fee amount are performed by a computer having programming designed to execute these steps.

65. The method of claim 64 wherein the data set further comprises data representing the first party's debt.

66. The method of claim 64 wherein the data set further comprises data representing the first party's deductible reimbursement obligations.

67. The method of claim 64 wherein the data set further comprises data representing the first party's collateral draw down triggers.

68. The method of claim 64 wherein the contractual obligation is created by a workers' compensation insurance contract.

69. The method of claim 64 wherein the contractual obligation is created by an automobile insurance contract.

70. The method of claim 64 wherein the step of receiving a data set comprises scanning the policyholder's credit facility documents using optical scan technology.

71. The method of claim 64 wherein the receiving a data set comprises scanning said agreements using optical scan technology.

72. The method of claim 64, wherein the collateral comprises assets to be deposited into a trust for the benefit of the second party.

73. The method of claim 72, wherein the assets comprise cash.

74. The method of claim 72 wherein the assets comprise securities.

75. A method of implementing an alternative collateral transaction that provides collateral on behalf of a first party under a contractual obligation to provide collateral to an second party, wherein said contractual obligation gives rise to subrogation, using an alternative collateral transaction that provides maximum protection of the collateral provider's rights against the first party and does not violate or breach the first party's existing credit agreements, the method comprising the steps of:
assessing the credit-worthiness of a first party under a contractual obligation to provide collateral to a second party, wherein the contractual obligation gives rise to subrogation, said assessment comprising the steps of receiving a data set relating to the first party, analyzing said data set, and outputting whether an alternative collateral transaction is allowed or disallowed for the first party based on the analysis of the data set;
identifying factors relevant to the policyholder's creditworthiness;
assigning weighting fractions of 0.01 to 0.99 to said factors relevant to the policyholder's creditworthiness;
assigning the policyholder a positive score of 1.0 or negative score of 1.0 for each factor;
multiplying the weighting fraction by the applicable factor score to produce a weighted adjusted score;
obtaining the sum of all weighted adjusted scores;
outputting whether an alternative collateral transaction is allowed or disallowed based on the sum of all weighted adjusted scores;
calculating a fee amount to charge said first party based on the credit-worthiness of the first party and amount of collateral required in exchange for providing collateral to the second party to satisfy the first party's contractual obligation;
displaying said fee amount; and
wherein at least the steps of assessing the credit-worthiness of a first party, assigning weighting fractions, assigning the policyholder a positive score of 1.0 or negative score of 1.0, multiplying the weighted fraction by the applicable factor score, obtaining the sum of all weighted adjusted scores, outputting whether an alternative collateral transaction is allowed or disallowed, calculating a fee amount, and displaying said fee amount are performed by a computer having programming designed to execute these steps.

76. The method of claim 75 wherein the data set further comprises data representing the first party's debt.

77. The method of claim 75 wherein the data set further comprises data representing the first party's deductible reimbursement obligations.

78. The method of claim 75 wherein the data set further comprises data representing the first party's collateral draw down triggers.

79. The method of claim 75 wherein the contractual obligation is created by a workers' compensation insurance contract.

80. The method of claim 75 wherein the contractual obligation is created by an automobile insurance contract.

81. The method of claim 75 wherein the step of receiving a data set comprises scanning the policyholder's credit facility documents using optical scan technology.

82. The method of claim 75 wherein the receiving a data set comprises scanning said agreements using optical scan technology.

83. The method of claim 75, wherein the collateral comprises assets to be deposited into a trust for the benefit of the second party.

84. The method of claim 83, wherein the assets comprise cash.

85. The method of claim 83 wherein the assets comprise securities.

86. A non-transitory computer-readable medium for implementing a transaction to provide collateral on behalf of a first party under a contractual obligation to provide collateral to an second party, wherein said contractual obligation gives rise to subrogation, using an alternative collateral transaction that provides maximum protection of the collateral provider's rights against the first party and does not violate or breach the first party's existing credit agreements, and in which a party providing the alternative collateral transaction vehicle provides collateral to the second party to satisfy the first party's collateral obligation, said computer-readable medium bearing a computer program containing instructions which, when implemented by a computer, cause the computer to execute the steps of:
receiving a data set relating to the first party;
analyzing said data set to determine the credit-worthiness of the first party;
outputting whether an alternative collateral transaction is allowed or disallowed for the first party based on the analysis of the data set;
receiving data representing the amount of collateral required by the contractual obligation;
calculating a fee amount to charge said first party based on the credit-worthiness of the first party and amount of collateral required in exchange for providing collateral to the second party to satisfy the first party's contractual obligation; and
displaying said fee amount.

87. The method of claim 86 wherein the data set further comprises data representing the first party's debt.

88. The method of claim 86 wherein the data set further comprises data representing the first party's deductible reimbursement obligations.

89. The method of claim 86 wherein the data set further comprises data representing the first party's collateral draw down triggers.

90. The method of claim 86 wherein the contractual obligation is created by a workers' compensation insurance contract.

91. The method of claim 86 wherein the contractual obligation is created by an automobile insurance contract.

92. The method of claim 86 wherein the step of receiving a data set comprises scanning the policyholder's credit facility documents using optical scan technology.

93. The method of claim 86 wherein the receiving a data set comprises scanning said agreements using optical scan technology.

94. The method of claim 86, wherein the collateral comprises assets to be deposited into a trust for the benefit of the second party.

95. The method of claim 94, wherein the assets comprise cash.

96. The method of claim 94 wherein the assets comprise securities.
